(19) United States
(12) Patent Application Publication
(10) Pub. No.: US 2010/0102795 A1
(43) Pub. Date: Apr. 29, 2010

(54) BANDGAP VOLTAGE REFERENCE CIRCUIT

(76) Inventors: Yu-Min Sun, Taipei County (TW); Li-Chieh Chen, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/350,909

(22) Filed: Jan. 8, 2009

(30) Foreign Application Priority Data
Oct. 28, 2008 (TW) 097141330

(51) Int. Cl. G05F 3/16

(52) U.S. Cl. 323/313

(57) ABSTRACT

A voltage reference circuit includes an operational amplifier, an output P-type MOS transistor, a first resistor, a first BJT, a second BJT, a third resistor, and a plurality of output resistors connected in series. A gate of the output P-type MOS transistor is electrically connected to an output end of the operational amplifier, and a drain of the output P-type MOS transistor is electrically connected to a voltage source. The gate of the output P-type MOS transistor is controlled by the output end of the operational amplifier, so that the drain current of the output P-type MOS transistor can match the current of the first resistor, the third resistor, and the plurality of output resistors connected in series.

### BACKGROUND OF THE INVENTION

1. Field of the Invention

The present invention relates to a bandgap voltage reference circuit, and more particularly, to a bandgap voltage reference circuit having an output transistor.

2. Description of the Prior Art

The voltage reference generator is an essential design block generally needed in analog and mixed circuits. It typically uses a bandgap reference circuit to generate a reference voltage that is relatively insensitive to the temperature and the supply voltage. The reference voltage output of the bandgap reference circuit according to the prior art is about 1.2V that is roughly equal to silicon bandgap energy measured at 0K in electron volts. Thus, the required supply voltage is at least 1.4V or higher.

The base-emitter voltage of the bipolar junction transistor (BJT) and the voltage difference between the base and the emitter of two BJTs are main factors determining the reference voltage. The base-emitter voltage has a negative temperature coefficient; that is, the base-emitter voltage decreases as the temperature increases. On the other hand, the voltage difference between the base and the emitter has a positive temperature coefficient; that is, the voltage difference between the base and the emitter increases as the temperature increases. To prevent the reference voltage varying as the temperature, the voltage difference between the base and the emitter is adjusted and added to the base-emitter voltage.

Please refer to FIG. 1. FIG. 1 is a schematic diagram of a bandgap reference circuit 10 according to the prior art. The bandgap reference circuit 10 includes an operation amplifier 12, a first R1, a first bipolar junction transistor (BJT) Q1, a second resistor R2, a second BJT Q2, a third resistor R3, a plurality of output resistor 14 connected in series, and an output capacitor 16. The base-emitter voltage of the first BJT Q1 operating in a forward active region can be expressed as:

Vbe=Vt*1n(Ic/Is)

Vt=kT/q

Where Ic is the collector current, Is is the saturation current, k is Boltzmann constant, T is temperature, q is electron charges, and Vt is the thermal voltage. Vt is about 26 mV at room temperature (˜300K).

The voltage across the resistor R2 is the voltage difference between the voltage Vbe1 and Vbe0, which can be expressed as:

ΔVbe=Vbe1−Vbe0=Vt*1n(n)

Where Vbe1 is the base-emitter voltage of the diode Q1, Vbe is the base-emitter voltage of the diode Q0. When the diode Q1 is n times the size of the diode Q2, the current through the resistor R1 is the same as that through the resistor R2. The output reference voltage can be expressed as:

$$Vref = Vbe 1 + R 1 * \frac{Vt * ln ( n )}{R 0} = Vbe 1 + Vt * M$$

The base-emitter voltage typically has a value of 0.6V and a negative temperature coefficient of −2 mV/K (complementary to absolute temperature, CTAT). The thermal voltage has a positive temperature coefficient of +0.085 mV/K (proportional to absolute temperature, PTAT). Thus, the output reference voltage can be insensitive to the temperature. When M=23, the reference voltage is about 0.6V+23*26 mV˜1.2V.

Please refer to FIG. 2. FIG. 2 is a circuitry of a bandgap reference circuit 10 according to the prior art. The operational amplifier includes a first current source 21, a second current source 22, two P-type Metal-Oxide-Semiconductor (MOS) transistor P1˜P2, and three N-type MOS transistor N1˜N3. When the reference circuit 10 outputs the voltage Vref, the current of the second current source 22 has to equal the sum of the currents I1, I2, and I3. However, when the plurality of output resistors 14 connected in series has variations in resistance, it will result in the current mismatch and influence the output voltage Vref of the reference circuit 10.

### SUMMARY OF THE INVENTION

According to an embodiment of the present invention, a bandgap reference circuit, comprises an operational amplifier, an output P-type MOS transistor, a first resistor, a first BJT, a second resistor, and a second BJT. The operational amplifier has a positive input end, a negative input end, and an output end. The output P-type MOS transistor has a gate electrically connected to the output end of the operational amplifier, a source electrically connected to a voltage source, and a drain. The first resistor has a first end electrically connected to the drain of the output P-type MOS transistor, and a second end electrically connected to the negative input end of the operational amplifier. The first BJT has an emitter electrically connected to the second end of the first resistor, a collector electrically connected to a ground, and a base. The second resistor has a first end electrically connected to the positive input end of the operational amplifier, and a second end. The second BJT has an emitter electrically connected to the second end of the second resistor, a collector electrically connected to the ground, and a base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a bandgap reference circuit according to the prior art.

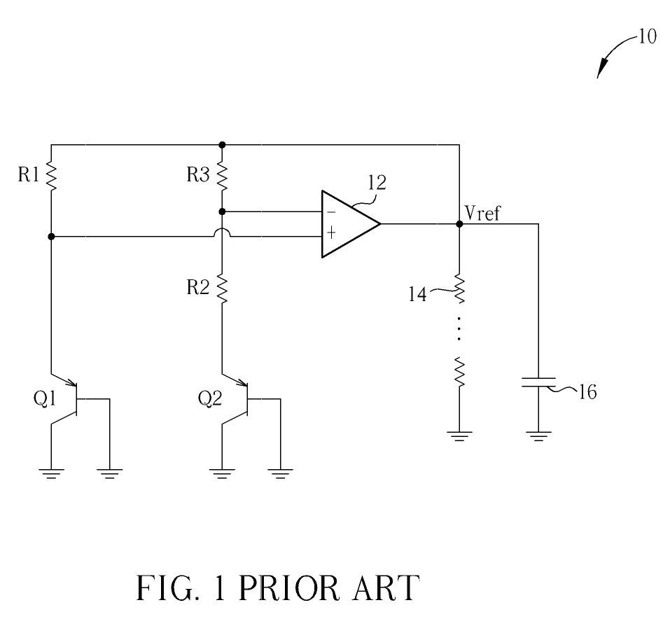

FIG. 2 is a circuitry of a bandgap reference circuit according to the prior art.

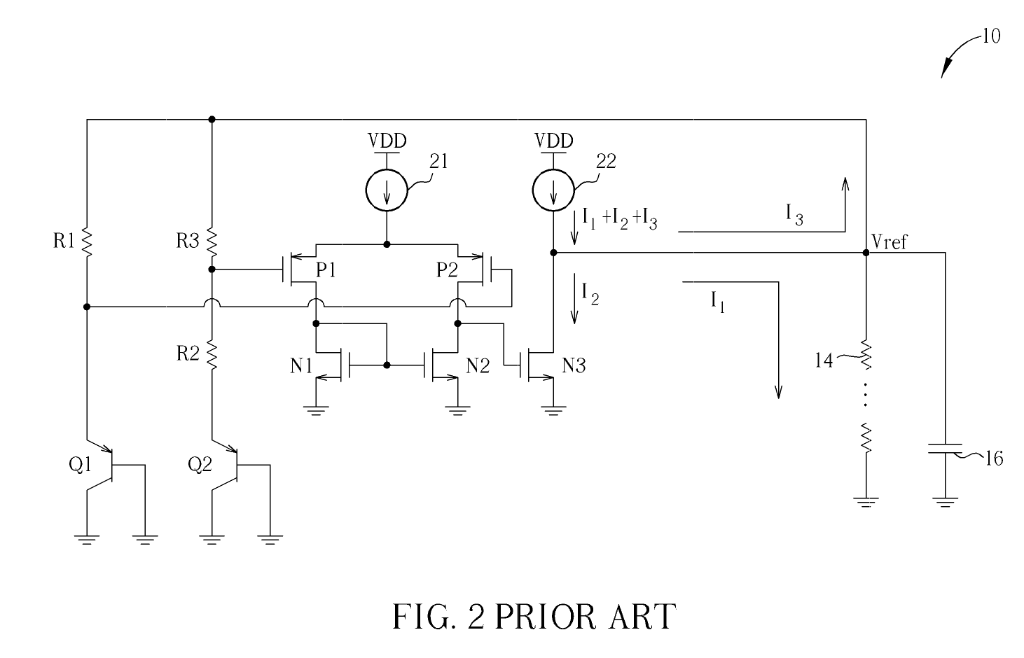

FIG. 3 is a circuitry of the first embodiment of a bandgap reference circuit according to the present invention.

FIG. 4 is a circuitry of the second embodiment of a bandgap reference circuit according to the present invention.

FIG. 5 is a circuitry of the third embodiment of a bandgap reference circuit according to the present invention.

### DETAILED DESCRIPTION

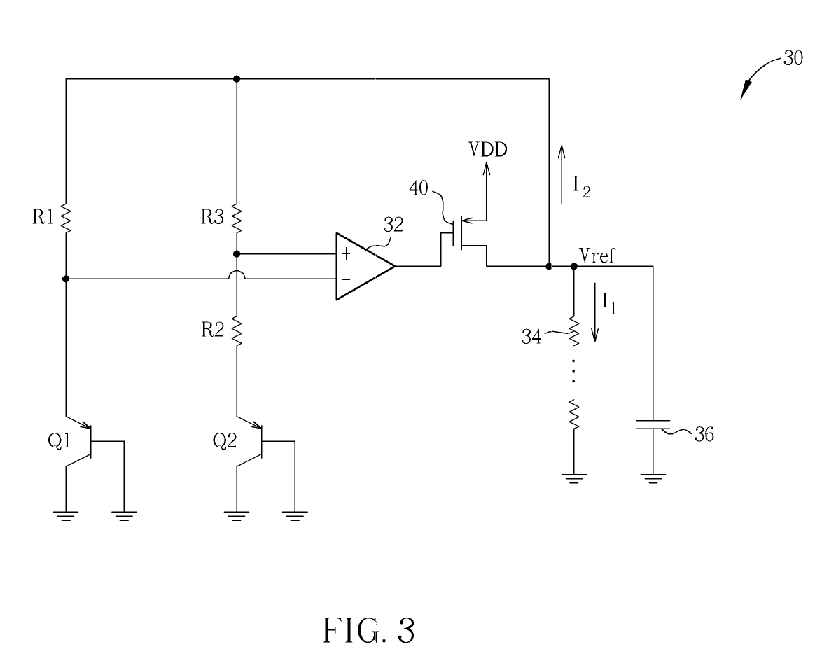

Please refer to FIG. 3. FIG. 3 is a circuitry of the first embodiment of a bandgap reference circuit 30 according to the present invention. The reference circuit 30 comprises an operational amplifier 32, an output P-type Metal-Oxide-Semiconductor (MOS) transistor 40, a first resistor R1, a first Bipolar Junction Transistor (BJT) Q1, a second resistor R2, a second BJT Q2, a third resistor R3, a plurality of output resistor 34 connected in series, and an output capacitor 36. The gate of the output P-type MOS transistor 40 is electrically connected to the output end of the operational amplifier 32. The source of the output P-type MOS transistor 40 is electrically connected to a voltage source VDD. The first end of the first resistor R1 is electrically connected to the drain of the output P-type MOS transistor 40. The second end of the first resistor R1 is electrically connected to the negative input end of the operational amplifier. The first end of the second resistor R2 is electrically connected to the positive input end of the operational amplifier 32. The second end of the second resistor R2 is electrically connected to the emitter of the second BJT Q2. The first end of the third resistor R3 is electrically connected to the drain of the output P-type MOS transistor 40. The second end of the third resistor R3 is electrically connected to the positive input end of the operational amplifier 32. The emitter of the first BJT Q1 is electrically connected to the second end of the first resistor R1. The collectors and the bases of the first BJT Q1 and the second BJT Q2 are electrically connected to a ground. The plurality of output resistor 34 connected in series is electrically connected between the drain of the output P-type MOS transistor 40 and the ground. The output capacitor 36 is electrically connected between the drain of the output P-type MOS transistor 40 and the ground. The gate of the output P-type MOS transistor 40 is controlled by the output of the operational amplifier 32, so that the drain current of the output P-type MOS transistor 40 can equal the sum of the current I1 and the current I2. Thus, the reference voltage generated by the bandgap reference circuit 30 does not influence by the current mismatch.

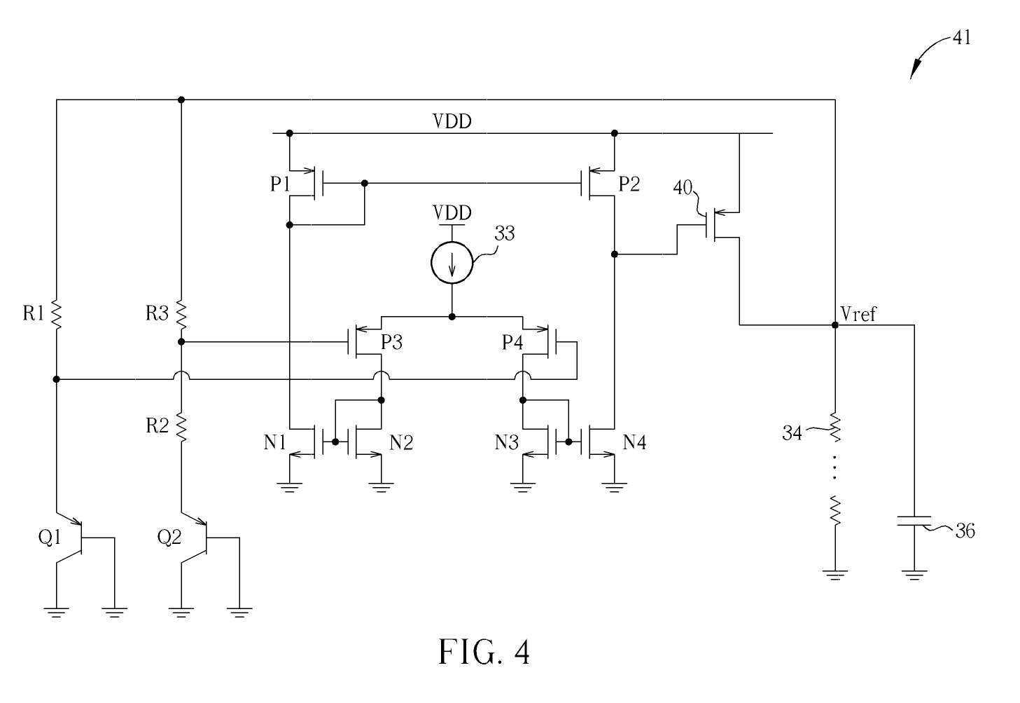

Please refer to FIG. 4. FIG. 4 is a circuitry of the second embodiment of a bandgap reference circuit 40 according to the present invention. In the second embodiment of the present invention, the operational amplifier comprises four P-type MOS transistors P1˜P4 and four N-type MOS transistors N1˜N4. The source of the first P-type MOS transistor P1 and the source of the second P-type MOS transistor P2 are electrically connected to the voltage source VDD. The gate of the first P-type MOS transistor P1 and the gate of the second P-type MOS transistor P2 are electrically connected to the drain of the first P-type MOS transistor P1. The drain of the second P-type MOS transistor P2 is electrically connected to the gate of the output P-type MOS transistor 40. The source of the third P-type MOS transistor P3 and the source of the fourth P-type MOS transistor P4 are electrically connected to a current source. The gate of the third P-type MOS transistor P3 is electrically connected to the first end of the second resistor R2. The gate of the fourth P-type MOS transistor P4 is electrically connected to the second end of the first resistor R. The gate of the first N-type MOS transistor N1 and the gate of the second N-type MOS transistor N2 are electrically connected to the drain of the third P-type MOS transistor P3. The drain of the first N-type MOS transistor N1 is electrically connected to the drain of the first P-type MOS transistor P1. The drain of the second N-type MOS transistor N2 is electrically connected to the drain of the third P-type MOS transistor P3. The gate of the third N-type MOS transistor N3 and the gate of the fourth N-type MOS transistor N4 are electrically connected to the drain of the fourth P-type MOS transistor P4. The drain of the third N-type MOS transistor N3 is electrically connected to the drain of the fourth P-type MOS transistor P4. The drain of the fourth N-type MOS transistor N4 is electrically connected to the drain of the second P-type MOS transistor P2. The sources of the first N-type MOS transistor N1, the second N-type MOS transistor N2, the third N-type MOS transistor N3, and the fourth N-type MOS transistor N4 are electrically connected to the ground.

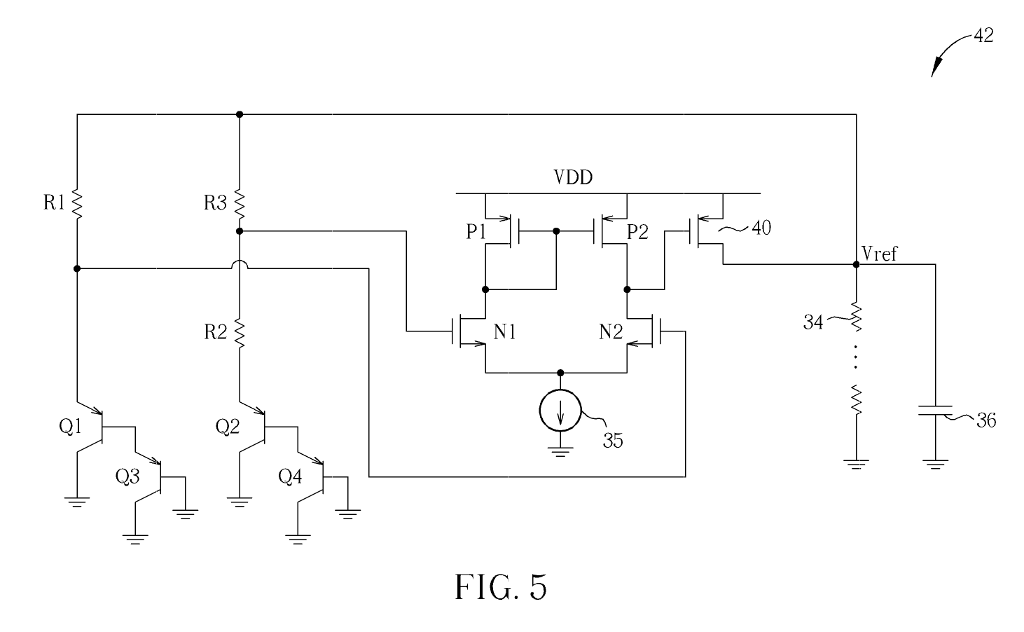

Please refer to FIG. 5. FIG. 5 is a circuitry of the third embodiment of a bandgap reference circuit 50 according to the present invention. In the third embodiment of the present invention, the operational amplifier comprises two P-type MOS transistors P1˜P2 and two N-type MOS transistors N1˜N2. In addition, the first BJT Q1 is electrically connected to a third BJT Q3. The second BJT Q2 is electrically connected to a fourth BJT Q4. Thus, the reference voltage Vref generated by the bandgap reference circuit 42 is greater than the reference voltage of the second embodiment. The source of the first P-type MOS transistor P1 and the source of the second P-type MOS transistor P2 are electrically connected to the voltage source VDD. The gate of the first P-type MOS transistor P1 and the gate of the second P-type MOS transistor P2 are electrically connected to the drain of the first P-type MOS transistor P1. The drain of the second P-type MOS transistor P2 is electrically connected to the gate of the output P-type MOS transistor 40. The gate of the first N-type MOS transistor N1 is electrically connected to the first end of the second resistor R2. The drain of the first N-type MOS transistor N1 is electrically connected to the drain of the first P-type MOS transistor P1. The gate of the second N-type MOS transistor N2 is electrically connected to the second end of the first resistor R1. The drain of the second N-type MOS transistor N2 is electrically connected to the drain of the second P-type MOS transistor P2. The source of the first N-type MOS transistor N1 and the source of the second N-type MOS transistor N2 are electrically connected to a current source. The emitter of the third BJT Q3 is electrically connected to the base of the first BJT Q1. The emitter of the fourth BJT Q4 is electrically connected to the base of the second BJT Q2. The collectors and the bases of the third BJT Q3 and the fourth BJT Q4 are electrically connected to the ground.

In conclusion, the voltage reference circuit according to the present invention comprises an operational amplifier, an output P-type MOS transistor, a first resistor, a first BJT, a second BJT, a third resistor, and a plurality of output resistors connected in series. A gate of the output P-type MOS transistor is electrically connected to an output end of the operational amplifier, and a drain of the output P-type MOS transistor is electrically connected to a voltage source. The gate of the output P-type MOS transistor is controlled by the output end of the operational amplifier, so that the drain current of the output P-type MOS transistor can match the current of the first resistor, the third resistor, and the plurality of output resistors connected in series. In addition, in the embodiment of the present invention, the operational amplifier comprises four P-type MOS transistors and four N-type MOS transistors. In another embodiment of the present invention, the operational amplifier comprises two P-type MOS transistors and two N-type MOS transistors, and uses two BJT connected in series so as to generate the higher reference voltage.

Those skilled in the art will readily observe that numerous modifications and alterations of the device and method may be made while retaining the teachings of the invention.

What is claimed is:

1. A bandgap reference circuit, comprising:
an operational amplifier, having a positive input end, a negative input end, and an output end;
an output P-type MOS transistor, having a gate electrically connected to the output end of the operational amplifier, a source electrically connected to a voltage source, and a drain;
a first resistor, having a first end electrically connected to the drain of the output P-type MOS transistor, and a second end electrically connected to the negative input end of the operational amplifier;
a first BJT, having an emitter electrically connected to the second end of the first resistor, a collector electrically connected to a ground, and a base;
a second resistor, having a first end electrically connected to the positive input end of the operational amplifier, and a second end; and
a second BJT, having an emitter electrically connected to the second end of the second resistor, a collector electrically connected to the ground, and a base.

2. The bandgap reference circuit of claim 1, further comprising:
a third resistor, having a first end electrically connected to the drain of the output P-type MOS transistor, and a second end electrically connected to the positive input end of the operational amplifier.

3. The bandgap reference circuit of claim 1, further comprising:
a plurality of output resistor connected in series, electrically connected between the drain of the output P-type MOS transistor and the ground.

4. The bandgap reference circuit of claim 1, further comprising:
an output capacitor, electrically connected between to the drain of the output P-type MOS transistor and the ground.

5. The bandgap reference circuit of claim 1, wherein the base of the first BJT is electrically connected to the ground and the base of the second BJT is electrically connected to the ground.

6. The bandgap reference circuit of claim 1, further comprising:
a third BJT, having an emitter electrically connected to the base of the first BJT, a collector electrically connected to the ground, and a base electrically connected to the ground; and
a fourth BJT, having an emitter electrically connected to the base of the second BJT, a collector electrically connected to a ground, and a base electrically connected to the ground.

7. The bandgap reference circuit of claim 1, wherein the operational amplifier comprises:
a first P-type MOS transistor, having a gate, a source electrically connected to the voltage source, and a drain electrically connected to the gate;
a second P-type MOS transistor, having a gate electrically connected to the drain of the first P-type MOS transistor, a source electrically connected to the voltage source, and a drain electrically connected to the gate of the output P-type MOS transistor;
a third P-type MOS transistor, having a gate electrically connected to the first end of the second resistor, a source electrically connected to a current source, and a drain;
a fourth P-type MOS transistor, having a gate electrically connected to the second end of the first resistor, a source electrically connected to the current source, and a drain;
a first N-type MOS transistor, having a gate electrically connected to the drain of the third P-type MOS transistor, a source electrically connected to the ground, and a drain electrically connected to the drain of the first P-type MOS transistor;
a second N-type MOS transistor, having a gate electrically connected to the drain of the third P-type MOS transistor, a source electrically connected to the ground, and a drain electrically connected to the drain of the third P-type MOS transistor;
a third N-type MOS transistor, having a gate electrically connected to the drain of the fourth P-type MOS transistor, a source electrically connected to the ground, and a drain electrically connected to the drain of the fourth P-type MOS transistor; and
a fourth N-type MOS transistor, having a gate electrically connected to the drain of the fourth P-type MOS transistor, a source electrically connected to the ground, and a drain electrically connected to the drain of the second P-type MOS transistor.

8. The bandgap reference circuit of claim 7, wherein the current source is electrically connected to the voltage source.

9. The bandgap reference circuit of claim 1, wherein the operational amplifier comprises:
a first P-type MOS transistor, having a gate, a source electrically connected to the voltage source, and a drain electrically connected to the gate;
a second P-type MOS transistor, having a gate electrically connected to the of the drain first P-type MOS transistor, a source electrically connected to the voltage source, and a drain electrically connected to the gate of the output P-type MOS transistor;
a first N-type MOS transistor, having a gate electrically connected to the first end of the second resistor, a source electrically connected to a current source, and a drain electrically connected to the drain of the first P-type MOS transistor; and
a second N-type MOS transistor, having a gate electrically connected to the second end of the first resistor, a source electrically connected to the current source, and a drain electrically connected to the drain of the second P-type MOS transistor.

10. The bandgap reference circuit of claim 9, wherein the current source is electrically connected to the ground.
